(19) United States
(12) Patent Application Publication
(10) Pub. No.: US 2025/0028917 A1
(43) Pub. Date: Jan. 23, 2025

(54) TWO-DIMENSIONAL BARCODE WITH SQUARES HAVING DIFFERENT COLOR PORTIONS

(71) Applicant: International Business Machines Corporation, Armonk, NY (US)

(72) Inventors: Jing Ran Yang, Shanghai (CN); Jia Tian Zhong, Beijing (CN); Wei Jun Zheng, Shanghai (CN); Sylvia Lo, Taipei (TW); Tian Yu Wang, Shanghai (CN); Yi Chen Zhang, Shanghai (CN)

(21) Appl. No.: 18/224,495

(22) Filed: Jul. 20, 2023

(51) Int. Cl. G06K 7/14

(52) U.S. Cl. CPC G06K 7/1417

(57) ABSTRACT

A computer-implemented method, according to one embodiment, includes creating a two-dimensional (2D) barcode that includes four perimeter sides. An array of a plurality of squares are included within the four perimeter sides. At least a first of the squares includes a first portion defined by a first diagonal line within the first square, a second portion defined by the first diagonal line, and a third portion defined by a first shape within the second portion. A computer program product, according to another embodiment, includes a computer readable storage medium having program instructions embodied therewith. The program instructions are readable and/or executable by a computer to cause the computer to perform the foregoing method. A system, according to another embodiment, includes a processor, and logic integrated with the processor, executable by the processor, or integrated with and executable by the processor. The logic is configured to perform the foregoing method.

### BACKGROUND

The present invention relates to barcodes, and more specifically, this invention relates to a two-dimensional (2D) barcode with squares having different color portions for correcting distortion.

A 2D barcode is machine code that can be scanned, e.g., by a smartphone, to obtain information almost instantly. Conventional 2D barcodes are widely used in the transmission of advertising media or useful information. For example, 2D barcodes are used for transmitting links to websites, information about product details, addresses, phone numbers, etc.

To retrieve information from a 2D barcode, normalization operation map an acquired code image into a standard rectangular image. For a planar code, such as a code displayed on the screen of a smartphone, the code image may be easily normalized.

### SUMMARY

A computer-implemented method, according to one embodiment, includes creating a two-dimensional (2D) barcode that includes four perimeter sides. An array of a plurality of squares are included within the four perimeter sides. At least a first of the squares includes a first portion defined by a first diagonal line within the first square, a second portion defined by the first diagonal line, and a third portion defined by a first shape within the second portion.

A computer program product, according to another embodiment, includes a computer readable storage medium having program instructions embodied therewith. The program instructions are readable and/or executable by a computer to cause the computer to perform the foregoing method.

A system, according to another embodiment, includes a processor, and logic integrated with the processor, executable by the processor, or integrated with and executable by the processor. The logic is configured to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2A is a flowchart of a method, in accordance with one embodiment of the present invention.

FIG. 2B is a flowchart of sub-operations of an operation of the flowchart of FIG. 2A, in accordance with one embodiment of the present invention.

FIG. 3 is a top down view of a 2D barcode, in accordance with one embodiment of the present invention.

FIG. 4A are linear arrays of identifier portions of a 2D barcode, in accordance with one embodiment of the present invention.

FIG. 4B are non-linear arrays of identifier portions of a 2D barcode, in accordance with one embodiment of the present invention.

FIG. 5 is a top down view of a 2D barcode, in accordance with one embodiment of the present invention.

FIGS. 6A-6D are top down views of a 2D barcode, in accordance with several embodiments of the present invention.

FIG. 6E is top down view of dye applied to the 2D barcode in FIGS. 6B-6D, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for creating and reading a two-dimensional (2D) barcode with squares having different color portions for correcting distortion.

In one general embodiment, a computer-implemented method includes creating a two-dimensional (2D) barcode that includes four perimeter sides. An array of a plurality of squares are included within the four perimeter sides. At least a first of the squares includes a first portion defined by a first diagonal line within the first square, a second portion defined by the first diagonal line, and a third portion defined by a first shape within the second portion.

In another general embodiment, a computer program product includes a computer readable storage medium having program instructions embodied therewith. The program instructions are readable and/or executable by a computer to cause the computer to perform the foregoing method.

In another general embodiment, a system includes a processor, and logic integrated with the processor, executable by the processor, or integrated with and executable by the processor. The logic is configured to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as barcode creation and read code of block 150 for creating and reading a two-dimensional (2D) barcode with squares having different color portions for correcting distortion. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

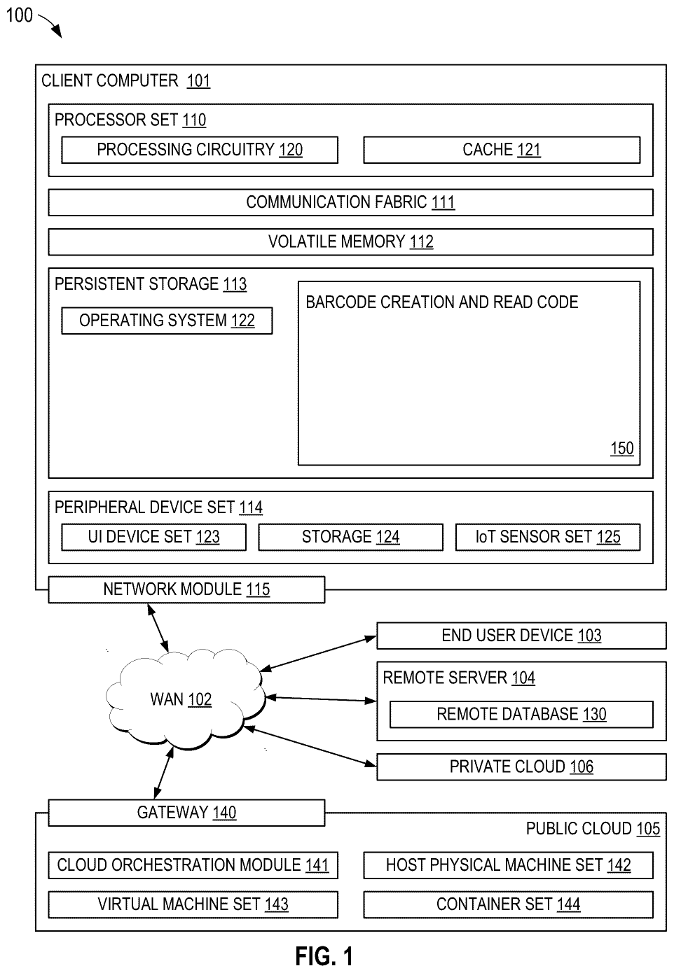

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere above, a 2D barcode is machine code that can be scanned, e.g., by a smartphone, to obtain information almost instantly. Conventional 2D barcodes are widely used in the transmission of advertising media or useful information. For example, 2D barcodes are used for transmitting links to websites, information about product details, addresses, phone numbers, etc.

To retrieve information from a 2D barcode, normalization operation map an acquired code image into a standard rectangular image. For a planar code, such as a code displayed on the screen of a smartphone, the code image may be easily normalized. However, in some use cases, 2D barcodes are posted on curved or even irregular surfaces, e.g., such as bottles, product packaging bags, clothing of athletes, etc. In these use cases, normalization of 2D barcodes is typically relatively difficult. Accordingly, information stored using these 2D barcodes is relatively often missed or caused to have a gross distortion. Industries such as retail, advertising, and financing use 2D barcodes to promote businesses and grow business revenues. Accordingly, there is a longstanding need within several industries for a barcode that is not missed or distorted when used on various surfaces.

In sharp contrast to the deficiencies described above, embodiments and approaches described herein correct distortion and solve the problem of identifying and normalizing 2D barcodes that are posted on curved surfaces. More specifically, these embodiments and approaches create and use a novel code pattern that includes color segments. Within these embodiments and approaches, a distinguishable color is incorporated into black and white modules. These distinguishable portions of the 2D barcode establish dividing lines that are used during the code normalization process. These embodiments and approaches also enable and use alternate black and white round dots as position identifiers.

These embodiments and approaches introduce a code pattern with the use of color segments to correct distortion and solve the problem of identifying and normalizing 2D barcodes that are posted on curved surfaces. The design of the created 2D barcode introduces a third color segment in the 2D barcode, and the color used is distinguishable and with high chroma value. The third color segment is used to differentiate black and white portions and relatively enhances the reading accuracy of a distorted 2D barcode, while enabling the data storage to be successfully retained without any losses. More specifically, in some preferred approaches, the proposed 2D barcode pattern includes triangles generated by using diagonal lines to divide square boxes (original data cells). A lower left portion of each divided square is used to store data, e.g., represent a predetermined value, while the upper right portion is a distinguishable color segment that helps to enhance the accuracy of reading the 2D barcode when posted on a curved surface. Using this design, a position and direction of the black/white portions of the 2D barcode where data is stored are identifiable because it is known that the third color segment is preferably always at the upper right portion of each square. This enables relatively accurate positioning without additional squares being added to the 2D barcode, e.g., such as position detection patterns which otherwise consume even more space on a surface that the barcode is printed on. The 2D barcode also preferably includes additional identifier portions, which are placed in color segment portions as a marking to differentiate a first square from an adjourning square. By applying these additional identifiers, each of the squares of a 2D barcode are identifiable even when the 2D barcode is distorted, thereby allowing for a precise reading of the 2D barcode.

Using the color segments described above, 2D barcodes which are posted on curved surfaces are correctly normalized relatively easily. This in turn mitigates the identification gaps that are otherwise caused by distortion of traditional 2D barcodes. Techniques described herein also enable a barcode locating mechanism in which a predetermined read process is performed that includes correcting distortion and ensuring the accuracy of normalization of 2D barcodes.

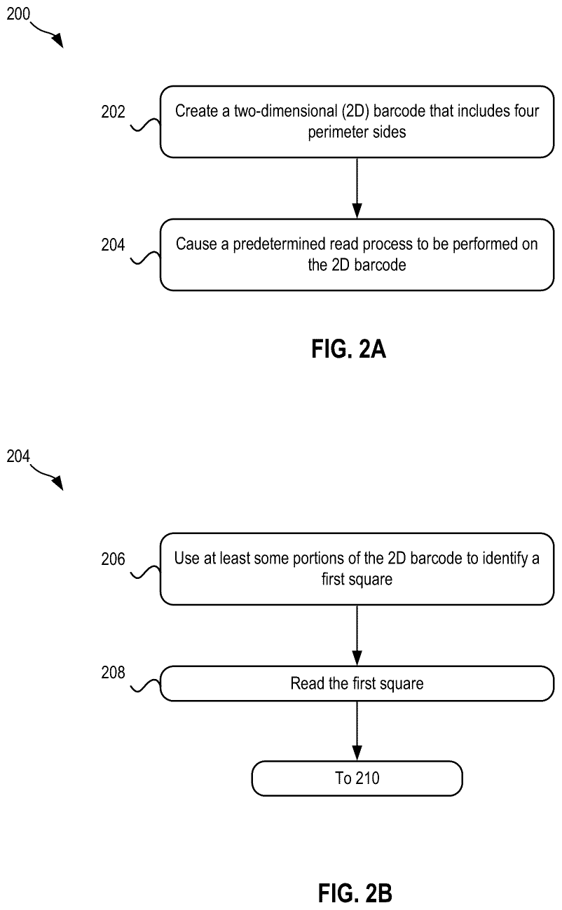

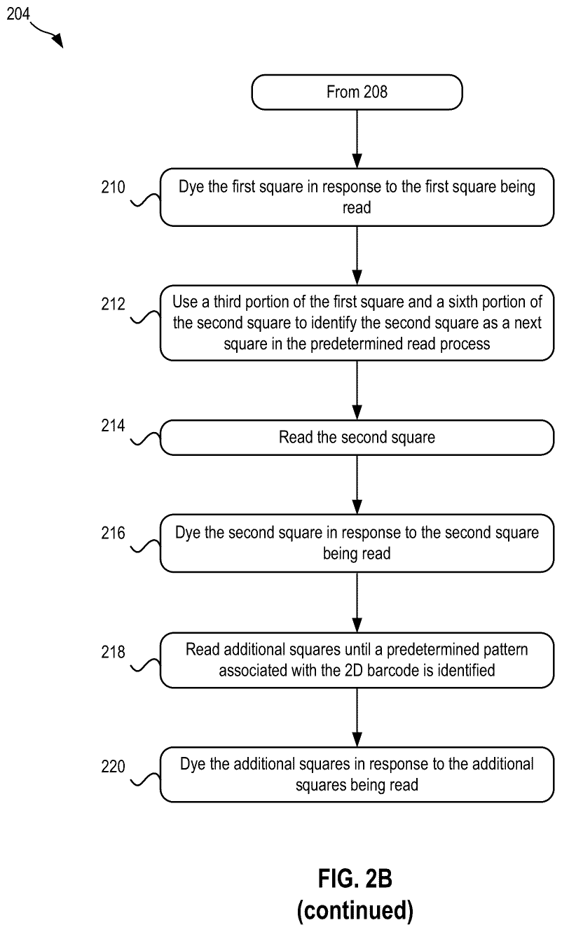

Now referring to FIG. 2A, a flowchart of a method 200 is shown according to one embodiment. The method 200 may be performed in accordance with the present invention in any of the environments depicted in FIGS. 1-6E, among others, in various embodiments. Of course, more or fewer operations than those specifically described in FIG. 2A may be included in method 200, as would be understood by one of skill in the art upon reading the present descriptions.

Each of the steps of the method 200 may be performed by any suitable component of the operating environment. For example, in various embodiments, the method 200 may be partially or entirely performed by a computer, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

Operation 202 includes creating a 2D barcode that includes four perimeter sides. In some approaches, the 2D barcode is created by issuing one or more instructions to a predetermined device, e.g., an inkjet printer, a laser printer, a daisy wheel printer, a three-dimensional (3D) printer, a laser etching device, etc., that is configured to print a 2D barcode on a predetermined surface, e.g., paper, metal, clothing, a curved surface, etc. The 2D barcode may, in some preferred approaches, be a square that is defined by four connected perimeter sides. In some other approaches, the 2D barcode may be a rectangle that is defined by four connected perimeter sides.

In some preferred approaches, an array of a plurality of squares, e.g., “cells”, are included within the four perimeter sides of the created 2D barcode. The array configuration and number of squares that are included in the array may depend on the approach. For example, in one preferred approach, the array includes a plurality of squares arranged in a ten square by eight square configuration. In another approach, the array includes a plurality of squares arranged in a ten square by ten square configuration. In yet some other approaches, the array includes a plurality of squares arranged in, e.g., a two square by two square configuration, a four square by four square configuration, a fifty square by fifty square configuration, etc.

Each of the squares are preferably the same size in some approaches, although in some other approaches, at least some of the squares of the array may be a different size than other squares in the array. For example, in some approaches, at least one of the squares in the array may include a plurality of sub-squares that have similar portions, e.g., a first portion, a second portion, a third portion, etc., to other squares that are larger than the sub-squares. Such portions of the squares will now be described in greater detail below.

In some preferred approaches, at least a first of the squares, and preferably a plurality of the squares, includes a plurality of portions. For context, the portions of the first square may be used in a predetermined read process in order to identify a predetermined pattern in the 2D barcode during use of the barcode, e.g., as described elsewhere herein in operation 204 of method 200. Within at least the first square, the first square may, in some approaches, include a first portion defined by a first diagonal line within the first square. The first diagonal line may additionally and/or alternatively define a second portion, in some approaches. For example, the first diagonal line may, in some approaches, cut across the first square and have endpoints at opposite diagonal corners of the first square. In such approaches, the first portion and the second portion are triangles, and the hypotenuses of the triangles are the first diagonal line.

At least the first square may additionally and/or alternatively include a third portion. In some preferred approaches, the third portion is defined by a first shape within the second portion. The first shape is preferably a circle, although in some other approaches, the first shape may be another predetermined shape, e.g., a square, a triangle, an oval, a trapezoid, etc. The third portion is preferably positioned at the center of the second portion, e.g., positioned in the center of the second triangle. In some other approaches, the third portion may alternatively be positioned outside of the center of the second triangle, e.g., such as in a predetermined one of the corners of the second triangle.

For context, the third portion, in some preferred approaches, serves as an “additional identifier” that may be identified and used within the second portion of a square as a marking to differentiate a first square from an adjoining square, e.g., differentiate a first square from a second square that is directly next to the first square. By incorporating these additional identifiers in the squares of the 2D barcode, squares of the 2D barcode are able to be identified during a predetermined read process even despite one of more of the squares being distorted. This further enables a precise reading of the 2D barcode elements.

Various approaches below detail color schemes that may be applied to the different portions of the 2D barcode.

In some preferred approaches, the first portion is a first color, and the second portion is a second color that is different than the first color. For example, in at least some of such approaches, the color of the first portion of at least some of the squares of the 2D barcode is black, and the color of the first portion of at least some of the other squares of the 2D barcode is white. In some approaches, the first portions of the squares are only positioned at the bottom left of the squares, e.g., the lower left triangle. As a result of causing the first portions of the squares to only be positioned at a bottom left of the squares, the black and white triangles will also only appear at the bottom left corner of the squares, in some approaches. This distinction may be known to a processor that performs the predetermined read process described elsewhere herein, and thereby used to indicate an orientation direction for reading the 2D barcode. The color of the first portion of a given one of the squares being black or white may also be used to represent a value of the given one of the squares, e.g., a value of zero may be pre-associated with the color black, a value of one may be pre-associated with the color white, or vice versa.

The second portion, in some preferred approaches, is preferably a different color than the color of the first portion. For context, the color of the second portion is preferably used to isolate the first portion of a given square, and therefore a color of the second portion is preferably an obvious color that is visibly differentiated from the color of the first portion. In one approach, the second portion is a blue color. In another approach, the second portion may be a gray color, which may be particularly useful in use cases where a color printer is not available for creating the 2D barcode.

A color of the third portion of a given one of the squares may, in some approaches, be a third color that matches the first color, e.g., a color of the first portion. For example, in some approaches, the third color is black or white. It should be noted that, because the third portion is preferably located within the second portion of a given one of the squares, the third color is different than the second color. In some other approaches, the third color may be different than the first color and different than the second color. For example, in one use case, the first portion of the first square may be the color white, the second portion of the first square may be the color blue, and the third portion of the first square may be the color black.

The third portion of each square is preferably used to find a third portion of a “next” neighbor square easily. For example, the third portions of the squares of the 2D barcode may be colored in a predetermined pattern. In such a predetermined pattern, along the same column of squares of the 2D barcode, every other third portion may be the color black, while the third portions of the remaining squares may be the color white, e.g., a black-white-black alternating pattern. Furthermore, in the predetermined pattern, along the same row of squares of the 2D barcode, every other third portion may be the color black, while the third portions of the remaining squares may be the color white, e.g., a black-white-black alternating pattern. In other words, the third portion of adjacent squares (squares having a common side) are not the same color. This way, the predetermined pattern may be followed during the predetermined read process in order to relatively easily find a next third portion based on knowing what color to expect. This is particularly useful for reading the 2D barcode where the 2D barcode is set in a deformed plane, e.g., such as printed on a wrinkled or otherwise deformed piece of clothing.

Although various approaches above detail the first of the squares of the 2D barcode, the 2D barcode may additionally and/or alternatively include a second square that includes a fourth portion, a fifth portion and a sixth portion. For example, the fourth portion may, in some approaches, be defined by a second diagonal line within the second square. Similarly, the fifth portion may be defined by the second diagonal line. The sixth portion may be defined by a second shape within the fifth portion, e.g., where the second shape is a circle that is located in a center of the fifth portion. The second square and the first square may touch along a common side of the second square and the first square. In order to distinguish the third portion of the first square from the sixth portion of the second square, the sixth portion of the second square is preferably a different color than the third portion of the first square. In some approaches, the color of the sixth portion matches the color of the fourth portion and preferably does not match the color of the fifth portion.

In some illustrative approaches, the fifth portion, in some preferred approaches, is preferably a different color than the color of the fourth portion. For context, the color of the fifth portion is preferably used to isolate the fourth portion of the second square, and therefore a color of the fifth portion is preferably an obvious color that is visibly differentiated from the color of the fourth portion. In one approach, the fifth portion is a blue color. In another approach, the fifth portion may be a gray color, which may be particularly useful in use cases where a color printer is not available for creating at least the second square of the 2D barcode.

A color of the sixth portion of the second square may, in some approaches, match the color of the fourth portion. For example, in some approaches, the sixth portion may be black or white. In some other approaches, the color of the sixth portion of the second square does not match the color of the fourth portion and/or does not match the color of the third portion, e.g., the first shape is a different color than the second shape.

Operation 204 of method 200 includes causing a predetermined read process to be performed on the 2D barcode. In other words, in some approaches, once the 2D barcode is created and potentially printed onto a predetermined surface, the 2D barcode may be read. Looking to FIG. 2B, exemplary sub-operations of causing a predetermined read process to be performed on the 2D barcode are illustrated in accordance with one embodiment, one or more of which may be used to perform operation 204 of FIG. 2A. However, it should be noted that the sub-operations of FIG. 2B are illustrated in accordance with one embodiment which is in no way intended to limit the invention.

Sub-operation 206 includes using at least some of the portions of the 2D barcode to identify the first square. As indicated elsewhere herein, the first portions of the squares are only positioned at the bottom left of the squares, e.g., the lower left triangle. Accordingly, in some approaches, using at least some of the portions of the 2D barcode to identify the first square may include recognizing that the 2D barcode is not oriented with the first portions in the bottom left of the squares. In response to identifying that the 2D barcode is not oriented with the first portions in the bottom left of the squares, method 200 may include causing the orientation of the 2D barcode to change, e.g., outputting an instruction for a user to flip an orientation of the surface that the 2D barcode is printed on, causing a processor that is analyzing the 2D barcode to consider the 2D barcode in a different orientation, etc.

In some preferred approaches, the first square, e.g., the square that is read first, is positioned in the bottom corner of the perimeter sides of the 2D barcode. This may be an initial read location for the predetermined read process. Sub-operation 208 includes reading the first square. Reading the first square may, in some approaches, include identifying and reading and/or processing the color combination of the first square. For example, in one or more of such approaches a color of one or more of the portions of the first square may be identified, and values associated with the identified colors of the portions may be determined, e.g., from a table that pre-associates portion colors with predetermined values.

Sub-operation 210 includes optionally dyeing the first square in response to the first square being read. For context, dyeing the first square may include, e.g., physically altering the 2D barcode printed on the predetermined surface, virtually applying a predetermined type of obscuration over an image of the 2D barcode that a processor component observes when performing the predetermined read process, etc. The dyeing of squares of the 2D barcode is, in some approaches, optional in that the dyeing may be applied in response to a determination that the 2D barcode is currently on an irregular surface. This determination may be based on an angular reading of the corners of the 2D barcode, an overall shape of the 2D barcode, a first read attempt of the 2D barcode taking more than a predetermined amount of time, etc.

The dying of the cells that are read may limit the amount of the 2D barcode that is analyzed and/or reanalyzed, thereby streamlining the reading of the 2D barcode, and particularly the identification of a next square in the predetermined read process. In some approaches, the additional identifiers, e.g., the circle shaped portion of the first square and/or a circle shaped portion of the next square, may additionally and/or alternatively be used to identify the next square in the predetermined read process. For example, sub-operation 212 includes using the third portion of the first square and the sixth portion of the second square to identify the second square as a next square in the predetermined read process. This sub-operation may include ruling another square out, e.g., a third square, as the next square in the predetermined read process in response to a determination that the third square has a circle shaped portion with a color that matches the color of the third portion of the first square. This sub-operation may additionally and/or alternatively include identifying the second as the next square in the predetermined read process in response to a determination that the second square has a circle shaped portion with a color that does not match the color of the third portion of the first square.

Sub-operation 214 includes reading the second square. The second square is optionally dyed in response to the second square being read, e.g., see sub-operation 216. Additional squares of the 2D barcode may be read until a predetermined pattern associated with the 2D barcode is identified, e.g., see sub-operation 218. In some approaches, as the blocks of a given column or row are read, a last block in the column or row of the 2D barcode may be reached. In response to a determination that a last block in the column or row of the 2D barcode has been reached, the predetermined read process may be resumed in a different column or block of the 2D barcode. The additional squares may optionally be dyed in response to the additional squares being read to thereby distinguish unread squares from squares that have already been read, e.g., see operation 220.

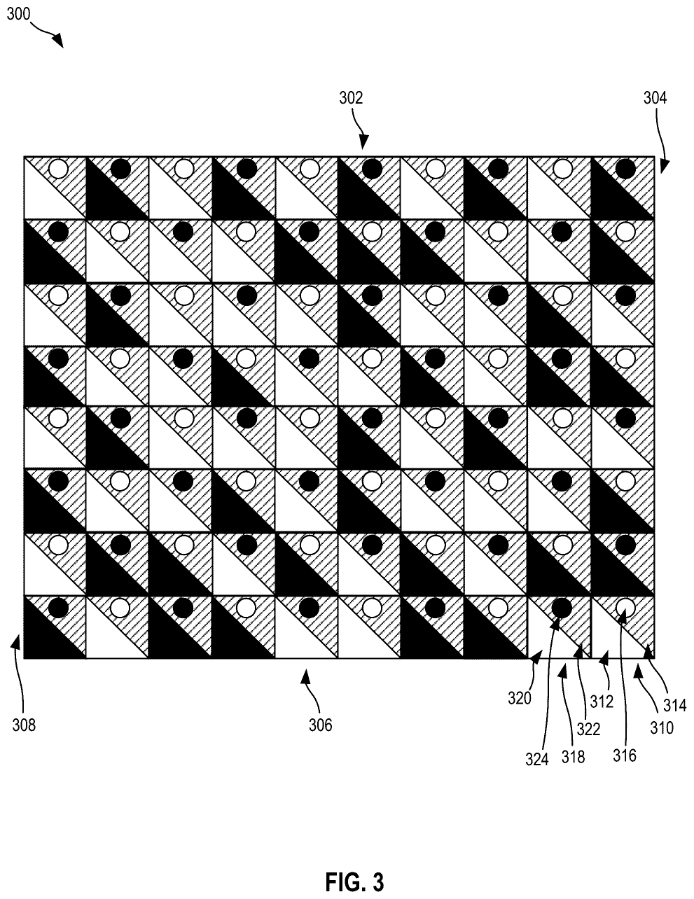

FIG. 3 depicts a 2D barcode 300, in accordance with one embodiment. As an option, the present 2D barcode 300 may be implemented in conjunction with features from any other embodiment listed herein, such as those described with reference to the other FIGS. Of course, however, such 2D barcode 300 and others presented herein may be used in various applications and/or in permutations which may or may not be specifically described in the illustrative embodiments listed herein. Further, the 2D barcode 300 presented herein may be used in any desired environment.

The 2D barcode 300 includes a plurality of connected perimeter sides, e.g., see a first side 302, a second side 304, a third side 306 and a fourth side 308. The 2D barcode includes an array of a plurality of squares that are included within the four connected perimeter sides. At least a first of the squares, e.g., see first square 310, includes a first portion 312 defined by a first diagonal line within the first square. The first square additionally includes a second portion 314 defined by the first diagonal line. Additionally, a third portion 316 is defined by a first shape within the second portion, e.g., a circle. A second of the squares, e.g., see first square 318, includes a fourth portion 320 defined by a diagonal line within the second square. The second square additionally includes a fifth portion 322 defined by the diagonal line, and a sixth portion 324 is defined by a shape within the sixth portion, e.g., a circle.

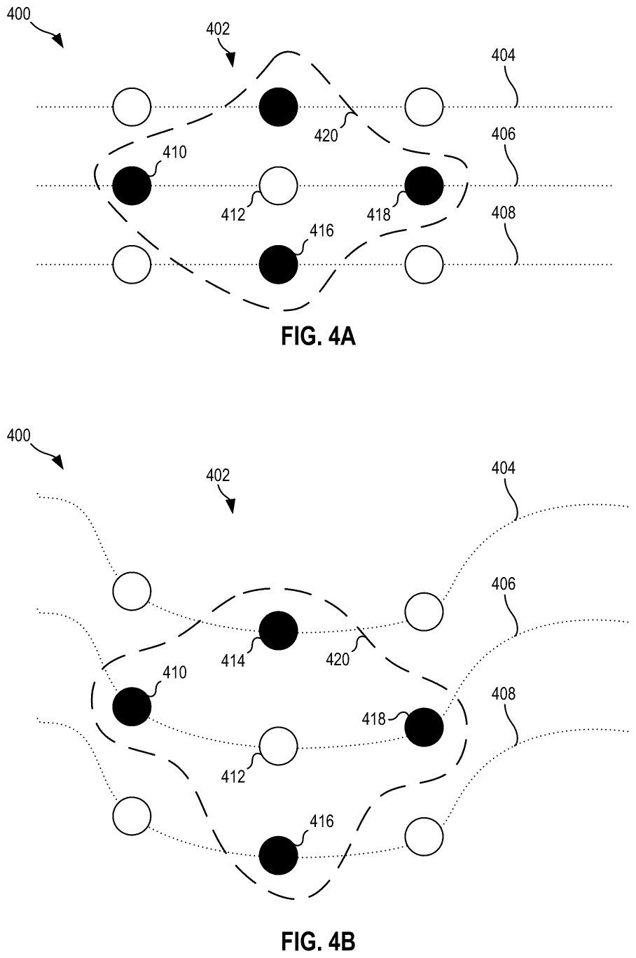

FIGS. 4A-4B depict an array 400 of identifier portions of a 2D barcode, in accordance with one embodiment. As an option, the present array 400 may be implemented in conjunction with features from any other embodiment listed herein, such as those described with reference to the other FIGS. Of course, however, such array 400 and others presented herein may be used in various applications and/or in permutations which may or may not be specifically described in the illustrative embodiments listed herein. Further, the array 400 presented herein may be used in any desired environment.

Referring first to FIG. 4A, the array 400 of circular shaped identifier portions 402 are arranged in rows having a predetermined pattern, e.g., alternating black and white color circles. For example, a first row 404 includes a plurality of identifier portions, a second row 406 includes a plurality of identifier portions, and a third row 408 includes a plurality of identifier portions. Note that other portions of squares that the identifier portions may otherwise be included in are omitted in FIGS. 4A-4B for purposes of brevity.

In FIG. 4A, the rows of identifier portions are all linear. This may be based on a surface that a 2D barcode that includes the identifier portions being printed on a level plane surface, e.g., a non-curved piece of paper. In contrast, referring now to FIG. 4B, the rows of identifier portions are all non-linear. This may be caused by the 2D barcode that includes the identifier portions being printed on a non-level plane surface, e.g., such as a piece of clothing that is wrinkled. Colors of the identifier portions may be used to identify a “next” neighbor square of any given square based on an understanding that identifier portions of proximate squares are not the same color. According to some more specific approaches, a pre-defined pattern is defined, e.g., for the black identifier 410 within the portion 420 of the plane surface, such that the “next” identifier, e.g., see white identifier 412, must be white. Even on a non-level plane surface, the identifier 412 is still the closest white identifier to the black identifier 410. Other neighbor identifiers are all black, e.g., see identifiers 414 and 416. The black identifier 418 can also be identified using similar techniques, which is the only close black identifier which is next to the identifier 412. Accordingly, the pre-defined pattern may be relatively easily used to find a correct “next” neighbor square of a 2D barcode.

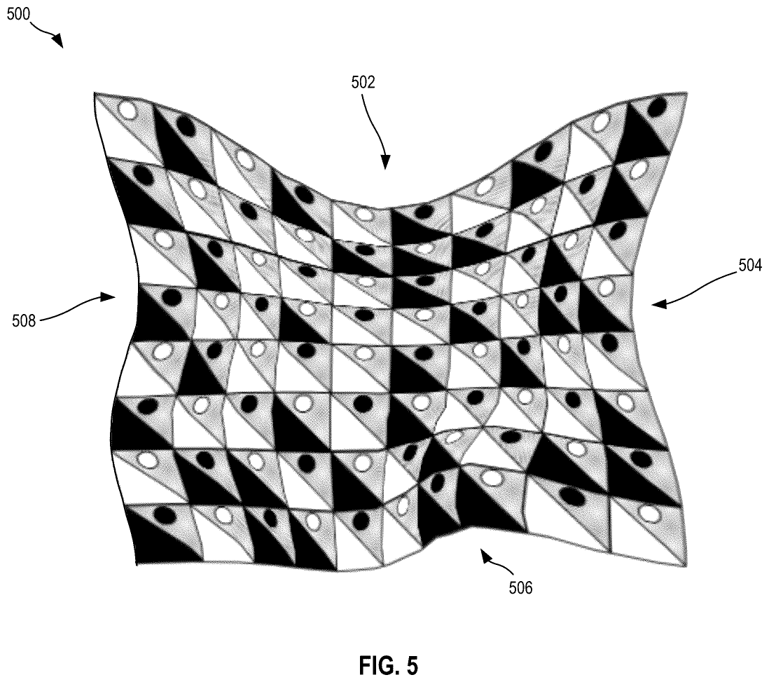

FIG. 5 depicts a 2D barcode 500, in accordance with one embodiment. As an option, the present 2D barcode 500 may be implemented in conjunction with features from any other embodiment listed herein, such as those described with reference to the other FIGS. Of course, however, such 2D barcode 500 and others presented herein may be used in various applications and/or in permutations which may or may not be specifically described in the illustrative embodiments listed herein. Further, the 2D barcode 500 presented herein may be used in any desired environment.

The 2D barcode 500 is a rectangular shaped barcode. However, in FIG. 5, the 2D barcode 500 has several areas of distortion, e.g., see areas 502, 504, 506 and 508, which may result from the 2D barcode being printed on an irregular surface. Despite these areas of distortion, the 2D barcode is still able to be read using techniques described herein. This is because the portions of the 2D barcode include a third color portion, e.g., triangle, to help isolate the other white and black portions.

It should be noted that these benefits are not otherwise available in conventional 2D barcodes and conventional 2D barcode reading techniques, which rely on a length of a rectangle and include portions of the same color. For at least these reasons, read inaccuracies otherwise occur in these conventional 2D barcode implementations when read on irregular surfaces as it becomes resource intensive (if even possible at all) to identify how many squares (of the same color) are in a deformed strip. This relatively reduces the identification gaps caused by deformation of the traditional QR code. Accordingly, the techniques of embodiments and approaches described herein enable 2D barcodes to be identified relatively easily with a simplified locator mechanism. This identification is enabled even in instances in which the 2D barcode is partly damaged, curved, distorted, etc., which relatively frequently occurs when 2D barcodes are printed on surfaces such as clothing, bottles, wrinkled paper, produce, etc.

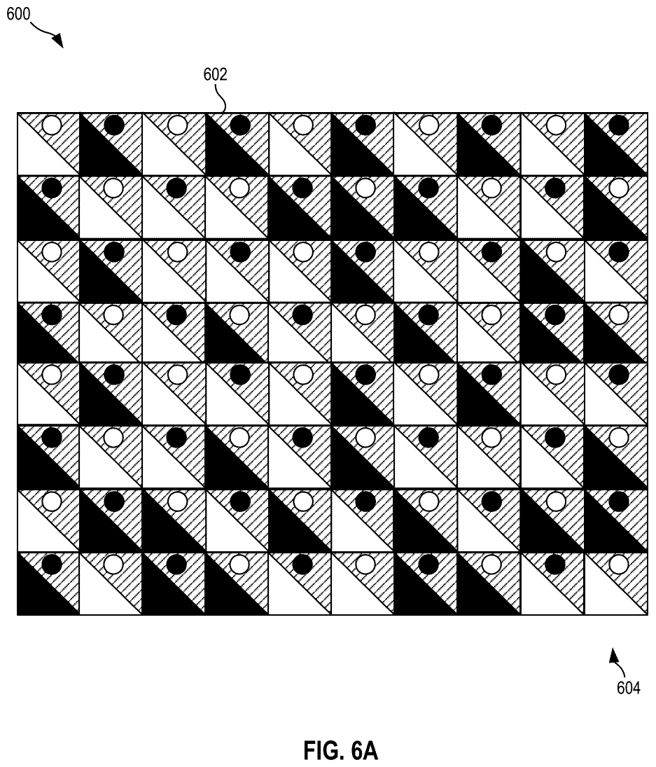

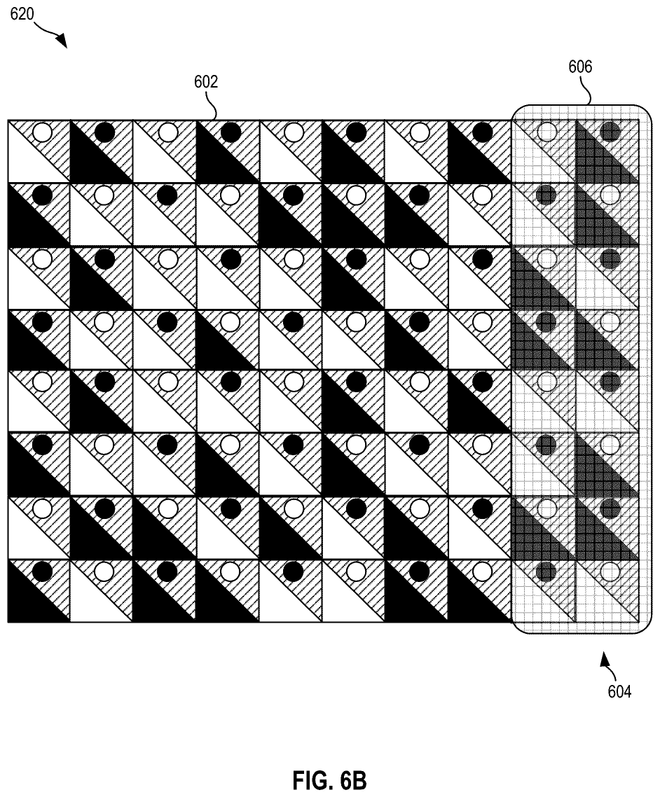

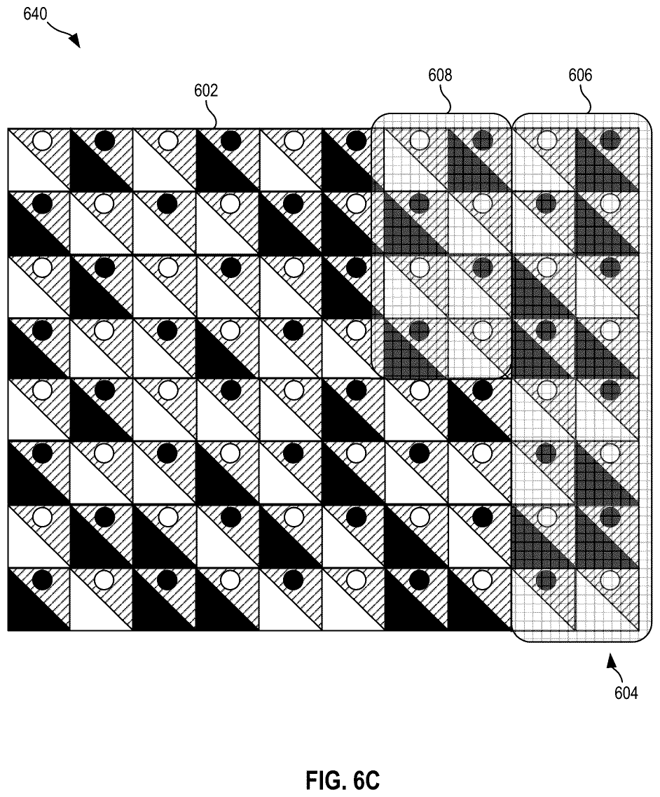

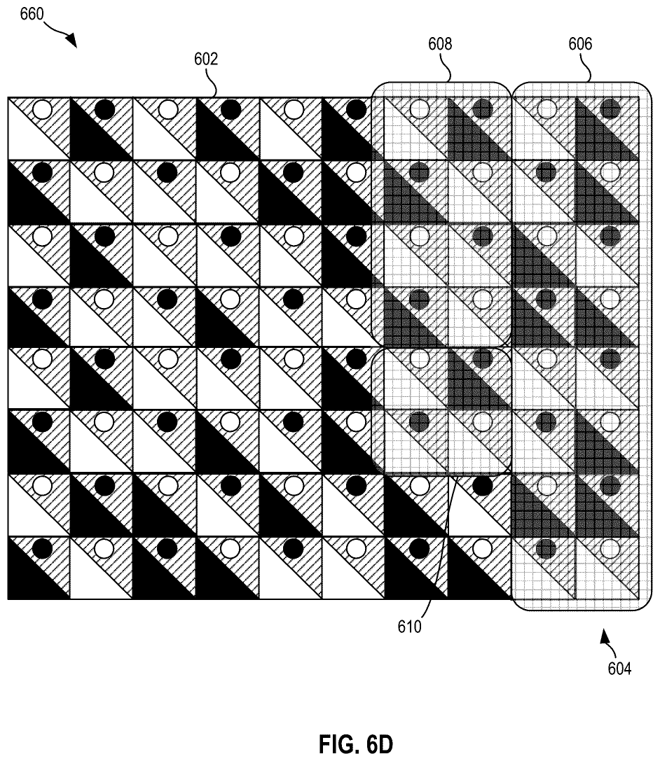

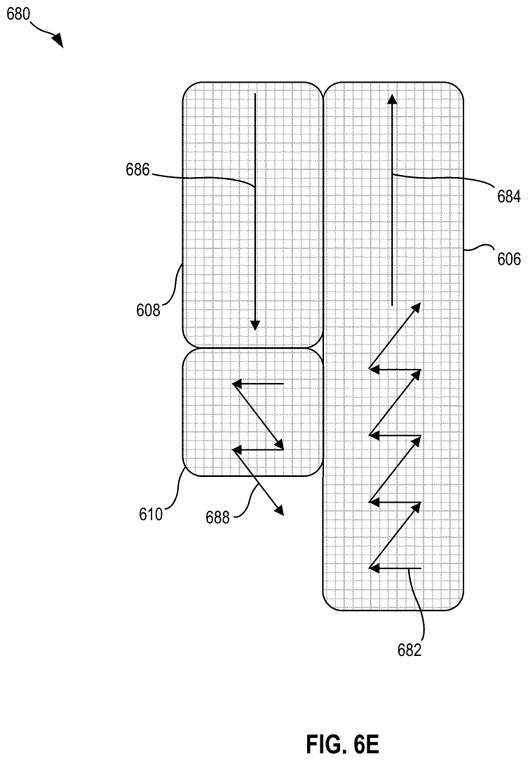

FIGS. 6A-6E depict views 600, 620, 640, 660, 680 of a progression of a 2D barcode being dyed during a predetermined read process being performed, in accordance with several embodiments. As an option, the present views 600 may be implemented in conjunction with features from any other embodiment listed herein, such as those described with reference to the other FIGS. Of course, however, such views 600 and others presented herein may be used in various applications and/or in permutations which may or may not be specifically described in the illustrative embodiments listed herein. Further, the views 600 presented herein may be used in any desired environment.

Referring first to FIG. 6A, the view 600 includes a 2D barcode 602 that is created using the techniques described herein. A predetermined read process may be performed on the 2D barcode. The predetermined read process, in some approaches, includes using at least some of the portions of the 2D barcode to identify a first square 604 that is positioned in a bottom corner of the perimeter sides of the 2D barcode.

Referring now to FIG. 6B, in the view 620 it may be assumed that as squares of the 2D barcode are read, dye is applied to squares in response to the squares being read, e.g., see dye portion 606. Referring now to views 640 and 660 of FIGS. 6C-6D, additional squares of the 2D barcode are read until a predetermined pattern associated with the 2D barcode is identified. As each of these additional squares are read, dye is applied to the additional squares, e.g., see dye portion 608 applied in FIG. 6C and dye portion 610 applied in FIG. 6D.

The view 680 in FIG. 6E includes the dye portions added to squares of the 2D barcode in FIGS. 6B-6D. For context, the dye portions are shown isolated in the view 680 in order to show a read path that is followed during performance of the predetermined read process. For example, after reading the first square of the 2D barcode, the read path continues to a second square, e.g., see operation 682. Additional squares are read along the read path until a last square in the squares covered by the dye portion 606 (dyed after reading) is read, e.g., see square read operation 684. Additional squares may be identified and read and dye operations may continue along the squares covered by the dye portion 608 (dyed after reading), e.g., see read operation 686, and along the squares covered by the dye portion 610 (dyed after reading), e.g., see read operation 688. It may be assumed that subsequent to performing the read operation 688, a predetermined pattern associated with the 2D barcode is identified.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
creating a two-dimensional (2D) barcode that includes four perimeter sides, wherein an array of a plurality of squares are included within the four perimeter sides, wherein at least a first of the squares includes:
a first portion defined by a first diagonal line within the first square,
a second portion defined by the first diagonal line, and
a third portion defined by a first shape within the second portion.

2. The computer-implemented method of claim 1, wherein the first portion and the second portion are triangles, wherein hypotenuses of the triangles are the first diagonal line.

3. The computer-implemented method of claim 1, wherein the first portion is a first color, wherein the second portion is a second color that is different than the first color.

4. The computer-implemented method of claim 3, wherein the first shape is a circle, wherein the first shape is a third color that matches the first color.

5. The computer-implemented method of claim 3, wherein the first shape is a circle, wherein the first shape is a third color that is different than the first color and that is different than the second color.

6. The computer-implemented method of claim 1, wherein at least a second of the squares includes:
a fourth portion defined by a second diagonal line within the second square,
a fifth portion defined by the second diagonal line, and
a sixth portion defined by a second shape within the fifth portion.

7. The computer-implemented method of claim 6, wherein the second square and the first square touch, wherein the second shape is a circle, wherein a color of the second shape is different than the color of the first shape.

8. The computer-implemented method of claim 7, wherein the color of the first portion, the color of the fourth portion, the color of the first shape, and the color of the second shape are selected from the group consisting of: black and white, wherein a color of the second portion and a color of the fifth portion match, wherein the color of the second portion and the color of the fifth portion are selected from the group consisting of gray and blue.

9. The computer-implemented method of claim 6, composing:
causing a predetermined read process to be performed on the 2D barcode, wherein the predetermined read process includes:
using at least some of the portions of the 2D barcode to identify the first square, wherein the first square is positioned in a bottom corner of the perimeter sides of the 2D barcode,
reading the first square,
dyeing the first square in response to the first square being read,
using the third portion of the first square and the sixth portion of the second square to identify the second square as a next square in the predetermined read process,
reading the second square,
dyeing the second square in response to the second square being read, reading additional squares of the 2D barcode until a predetermined pattern associated with the 2D barcode is identified, and
dyeing the additional squares in response to the additional squares being read.

10. A computer program product, the computer program product comprising a computer readable storage medium having program instructions embodied therewith, the program instructions readable and/or executable by a computer to cause the computer to:
create a two-dimensional (2D) barcode that includes four perimeter sides,
wherein an array of a plurality of squares are included within the four perimeter sides, wherein at least a first of the squares includes:
a first portion defined by a first diagonal line within the first square,
a second portion defined by the first diagonal line, and
a third portion defined by a first shape within the second portion.

11. The computer program product of claim 10, wherein the first portion and the second portion are triangles, wherein hypotenuses of the triangles are the first diagonal line.

12. The computer program product of claim 10, wherein the first portion is a first color, wherein the second portion is a second color that is different than the first color.

13. The computer program product of claim 12, wherein the first shape is a circle, wherein the first shape is a third color that matches the first color.

14. The computer program product of claim 12, wherein the first shape is a circle, wherein the first shape is a third color that is different than the first color and that is different than the second color.

15. The computer program product of claim 10, wherein at least a second of the squares includes:
a fourth portion defined by a second diagonal line within the second square,
a fifth portion defined by the second diagonal line, and
a sixth portion defined by a second shape within the fifth portion.

16. The computer program product of claim 15, wherein the second square and the first square touch, wherein the second shape is a circle, wherein a color of the second shape is different than the color of the first shape.

17. The computer program product of claim 16, wherein the color of the first portion, the color of the fourth portion, the color of the first shape, and the color of the second shape are selected from the group consisting of: black and white, wherein a color of the second portion and a color of the fifth portion match, wherein the color of the second portion and the color of the fifth portion are selected from the group consisting of gray and blue.

18. The computer program product of claim 15, the program instructions readable and/or executable by the computer to cause the computer to:
cause a predetermined read process to be performed on the 2D barcode, wherein the predetermined read process includes:
using at least some of the portions of the 2D barcode to identify the first square, wherein the first square is positioned in a bottom corner of the perimeter sides of the 2D barcode,
reading the first square,
dyeing the first square in response to the first square being read,
using the third portion of the first square and the sixth portion of the second square to identify the second square as a next square in the predetermined read process,
reading the second square,
dyeing the second square in response to the second square being read,
reading additional squares of the 2D barcode until a predetermined pattern associated with the 2D barcode is identified, and
dyeing the additional squares in response to the additional squares being read.

19. A system, comprising:
a processor; and
logic integrated with the processor, executable by the processor, or integrated with and executable by the processor, the logic being configured to:
create a two-dimensional (2D) barcode that includes four perimeter sides,
wherein an array of a plurality of squares are included within the four perimeter sides, wherein at least a first of the squares includes:
a first portion defined by a first diagonal line within the first square,
a second portion defined by the first diagonal line, and
a third portion defined by a first shape within the second portion.

20. The system of claim 19, wherein the first portion and the second portion are triangles, wherein hypotenuses of the triangles are the first diagonal line.
